(19) United States
(12) Patent Application Publication
(10) Pub. No.: US 2008/0297309 A1
(43) Pub. Date: Dec. 4, 2008

(54) WAVEFORM SYNTHESIS IN RFID INTERROGATORS

(76) Inventor: Marc Loyer, Sacramento, CA (US)

Correspondence Address: COOL PATENT, P.C.;c/o INTELLEVATE, P.O. BOX 52050, MINNEAPOLIS, MN, 55402, US

(21) Appl. No.: 11/754,641

(22) Filed: May 29, 2007

(51) Int. Cl. H04Q 5/22

(52) U.S. Cl. 340/10.1

(57) ABSTRACT

Briefly, in accordance with one or more embodiments, a waveform for a radio-frequency identification interrogator is capable of being synthesized with hardware by combining waveform samples stored in a waveform lookup table. A microcode table comprises microcode instructions relating to how to assemble the waveform samples into a waveform. A media access controller may interpret one or more commands to synthesize a waveform by accessing the microcode instructions stored in the microcode table.

### BACKGROUND

Waveform synthesis for devices such as radio-frequency identification (RFID) interrogators typically is performed in software in order to provide flexibility in the face of emerging and/or changing standards. Another approach to generating the transmit symbol stream is to start with an idealized stream and filter this using a programmable filter such as a finite impulse response (FIR) filter or the like. Although requiring less bandwidth than a complete software solution, such an approach would be flexible, but may impose excessive latency on the data stream, and would furthermore require the media access controller (MAC) to program the stream in real-time.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a radio-frequency identification (RFID) interrogator in accordance with one or more embodiments;

FIG. 2 is a block diagram of a circuit capable of synthesizing a waveform for the RFID interrogator of FIG. 1 in accordance with one or more embodiments;

FIG. 3 is a graph of a synthesized waveform in accordance with one or more embodiments; and

FIG. 4 is a diagram of a framesync symbol in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

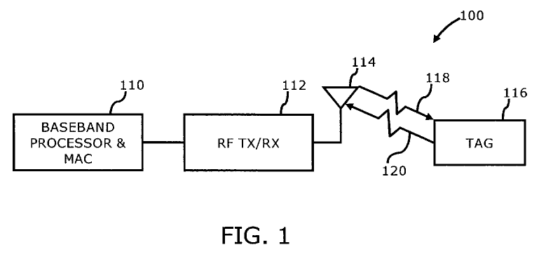

Referring now to FIG. 1, a block diagram of a radio-frequency identification (RFID) interrogator in accordance with one or more embodiments will be discussed. As shown in FIG. 1, RFID interrogator 100 generally may comprise a baseband processor and media access controller (MAC) 110 coupled to an RF transceiver 112 having a transmitter path and a receiver path. In one or more embodiments, baseband processor and media access controller 110 may comprise two or more discrete components or integrated circuits, and/or may comprise a single integrated circuit or processor, although the scope of the claimed subject matter is not limited in these respects. In one or more embodiments, baseband processor and MAC 110 may generate an interrogation waveform that is transmitted by RF transceiver 112 via antenna 114 as an interrogation signal 118. Interrogation signal 118 may be received by RFID tag 116 and may provide operational power to RFID tag 116 so that RFID tag 116 may transmit a tag response signal 120 back to RFID interrogator 100. The received tag response signal 120 may be demodulated and/or decoded by baseband processor and MAC 110 in order to determine information stored in tag 116, for example an identification code corresponding to tag 116. However, this is merely one example of the operation of RFID interrogator 100, and the scope of the claimed subject matter is not limited in this respect.

Referring now to FIG. 2, a block diagram of a circuit capable of synthesizing a waveform for the RFID interrogator of FIG. 1 in accordance with one or more embodiments will be discussed. In one or more embodiments, waveform synthesizer 200 uses a waveform lookup table 214, a microcode table 212, and/or a command fist in first out (FIFO) memory to provide a programmable arrangement for synthesizing RFID transmit symbol streams to be transmitted by RFID interrogator 100 to one or more RFID tags 116. The media access controller (MAC), implemented by baseband processor and MAC 110, either as a separate device or in combination, loads FIFO 210 with a specific desired data sequence, and as a result high-level waveform descriptions may be synthesized into a waveform, for example as discussed in further detail, below.

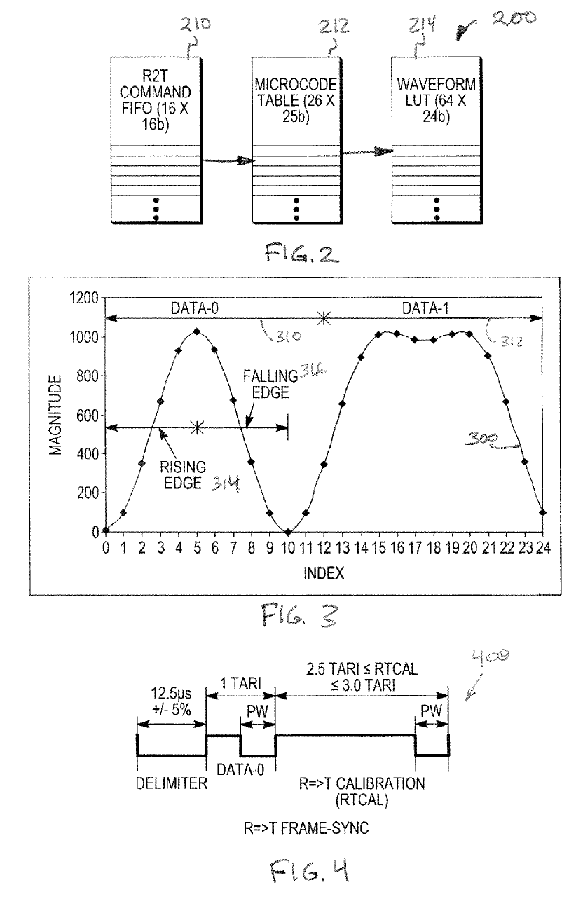

Referring now to FIG. 3, a graph of a synthesized waveform in accordance with one or more embodiments will be discussed. Waveform lookup table 214 contains the time-domain sampled signal values for the various symbols needed for the transmit stream represented by waveform 300. Such symbols may include “DATA-0” symbol 310, “DATA-1” symbol 312, and rising and falling transitions such as rising edge 314 and falling edge 316. The programmable waveform lookup table 214 supports all RFID modulation methods, including for example double side band (IQ-DSB), single side band (IQ-SSB), and/or amplitude-shift keying (PR-ASK). In one or more embodiments, the symbol boundaries can be chosen so that concatenations of a random stream of symbols will not have significant spectral leakage, or in other words symbol boundaries may be chosen such the combination of two or more symbols will not result in sharp transitions that may result in higher frequency components when such a combination of symbols is transmitted by RF transceiver 112 as a radio-frequency waveform.

Referring now to FIG. 4, a diagram of a framesync symbol in accordance with one or more embodiments will be discussed. In one or more embodiments, microcode table 212 includes information describing how to access waveform lookup table 214 in order to form the desired waveform. In other words, lookup table 214 includes portions of waveforms, and microcode table 212 includes information how to construct a desired waveform from the portions of waveforms stored in lookup table 214. For example, a “framesync” symbol 400 of FIG. 4 may be decomposed into a series of rising and falling edges, combined with one or more “wait” samples. This example is diagramed in Table 1, below. The microcode table 212 encodes this access information via “START”, “END”, and “HOLD” data fields in the microcode word.

TABLE 1
Microcode entries for synthesizing a FRAMESYNC symbol

| START | END | HOLD | DESCRIPTION |
|---|---|---|---|
| 5 | 10 | 14 | Falling transition, 12.5 μs delimiter |
| 0 | 10 | 0 | DATA-0 |
| 0 | 5 | 15 | Rising transition, RTCal |
| 5 | 10 | 0 | The rest of RTCal |

The contents of FIFO 210 are used to control access into microcode table 212. For example, FIFO 210 word includes address “ADDR” and length “LENGTH” fields. The “ADDR” field defines which microcode instruction of microcode table 212 to start execution from, and the “LENGTH” field defines how many microcode instructions are to be executed. Thus, in one or more embodiments, the entire “FRAMESYNC” symbol 400 may be generated through a single command of FIFO 210. In addition, the FIFO word may support other dedicated high-level commands, such as a byte send “SENDBYTE” and a random send “SENDRANDOM”. MAC of baseband processor and MAC 110 interprets the FIFO commands of FIFO 210, accesses microcode table 212 as directed by the FIFO command, and in turn accesses waveform lookup table 214 as instructed by the microcode instructions. In such an arrangement, an entire command such as a QUERY, ACK, NACK, READ, WRITE, LOCK, KILL, and so on, consisting of hundreds of waveform samples may be synthesized using just a smaller number of FIFO commands. These multiple levels allow complicated waveforms to be synthesized through a smaller number of instructions from the MAC, thus relieving the MAC from the burden of real-time operation. By performing waveform synthesis in hardware, the MAC of baseband processor and MAC 110 is capable of being realized by a lower performance microcontroller instead of a requiring a higher performance digital signal processor (DSP) engine. Thus, the complexity of RFID interrogator 100 may be reduced. Furthermore, by reducing the bandwidth of the interface between the MAC of baseband processor and MAC 110 and RF transceiver 112, simpler board designs and lower interface speeds may be facilitated. In addition, by utilizing pre-computed waveform shapes and storing these in lookup table 214, transmit latency of RFID interrogator 100 may be reduced or avoided. However, these are merely example embodiments of RFID interrogator 100, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to waveform synthesis in RFID interrogators and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A radio-frequency interrogator, comprising:
a media access controller; and
a first in, first out command memory, a microcode table, and a waveform lookup table;
wherein the media access controller is capable of synthesizing a waveform to be transmitted by interpreting one or more commands in the first in, first out command memory to access microcode stored in the microcode table to obtain waveform samples stored in the waveform lookup table from which the waveform is synthesized.

2. A radio-frequency interrogator as claimed in claim 1, wherein a word stored in the first in, first out command memory defines a microcode instruction to be executed.

3. A radio-frequency interrogator as claimed in claim 1, wherein a word stored in the first in, first out command memory defines a number of microcode instructions to be executed to synthesize a waveform.

4. A radio-frequency interrogator as claimed in claim 1, wherein the media access controller is capable of being realized by a lower performance microcontroller without requiring a higher performance digital signal processor.

5. A radio-frequency interrogator as claimed in claim 1, wherein the waveform comprises a symbol that is capable of being synthesized via a single command for the first in, first out command memory.

6. A radio-frequency interrogator as claimed in claim 1, wherein an interface between the media access controller and a radio-frequency transceiver capable of transmitting the synthesized waveform is capable of being realized at a lower bandwidth.

7. A radio-frequency interrogator as claimed in claim 1, wherein a command is capable of being synthesized via a smaller number of commands for the first in, first out command memory, the command comprising QUERY, ACK, NACK, READ, WRITE, LOCK, or KILL, or combinations thereof.

8. A radio-frequency interrogator as claimed in claim 1, wherein the waveform samples stored in the waveform lookup table comprise DATA-0 samples, DATA-1 samples, rising edge samples, or falling edge samples, or combinations thereof

9. A radio-frequency interrogator as claimed in claim 1, further comprising an RF transceiver coupled to the media access controller, and an antenna coupled to the RF transceiver.

10. A method, comprising:
interpreting one or more commands to synthesize a waveform;
accessing one or more microcode instructions store in a microcode table in response to said interpreting;
obtaining one or more samples of a waveform stored in a waveform lookup table in response to said accessing; and
synthesizing a waveform according to the microcode instructions to result in a waveform specified by the one or more commands.

11. A method as claimed in claim 10, said interpreting comprising executing the commands in a first in, first out memory.

12. A method as claimed in claim 10, wherein the samples of the waveform are arranged to reduce higher frequency content in a synthesized waveform.

13. A method as claimed in claim 10, said synthesizing comprising synthesizing a symbol in response to a single command.

14. A method as claimed in claim 10, said synthesizing comprising synthesizing an entire command using a smaller number of commands, the command comprising QUERY, ACK, NACK, READ, WRITE, LOCK, or KILL, or combinations thereof.

15. A method as claimed in claim 10, said interpreting, said accessing, said obtaining, or said synthesizing, or combinations thereof, is capable of being performed in hardware without requiring software.
